(19) United States
(12) Patent Application Publication
(10) Pub. No.: US 2009/0247369 A1
(43) Pub. Date: Oct. 1, 2009

(54) HYGIENIC EXERCISE EQUIPMENT AND MANUFACTURING METHOD THEREOF

(76) Inventor: Shuo-Hsiu Johnny Chang, Taipei City (TW)

Correspondence Address: WPAT, PC, 7225 BEVERLY ST., ANNANDALE, VA, 22003, US

(21) Appl. No.: 12/390,624

(22) Filed: Feb. 23, 2009

Related U.S. Application Data
(60) Provisional application No. 61/040,100, filed on Mar. 27, 2008.

(51) Int. Cl. C08F 214/06; A63B 21/072; A63B 21/06; A63B 23/16; A63B 21/065; A63B 22/16; A63B 5/20; A47G 9/06; B28B 1/14

(52) U.S. Cl. 482/49; 482/108; 482/106; 482/93; 482/105; 482/146; 482/82; 5/417; 524/567; 264/299

(57) ABSTRACT

A hygienic exercise equipment includes thermo plastic elastomer having a composition comprising bamboo charcoal powder, PVC, ZN-CA stabilizer, pour point depressant, ink and at least one of DOP and ATBC. Preferably, bamboo charcoal from 0.1% to 5%, PVC from 35% to 56%, ZN-CA stabilizer from 0.4% to 1.5%, pour point depressant from 0.5% to 1.5%, ink from 0% to 10%, and at least one of DOP and ATBC from 1.0% to 5%. The composition is mixed and tailored to various designs for different exercise equipment, different parts and different portion of the exercise equipment. The internal body in the weight trainer, due to being mixed with the solid powder, has an extremely high density ranging from 0.5 g/cm.sup.3 to 6 g/cm.sup.3, preferably ranging from 4 g/cm.sup.3 to 6 g/cm.sup.3, so the weight trainer can have a high weight, even if fitted into the internal body with small volume.

### CROSS-REFERENCE TO RELATED APPLICATIONS

This application claims priority to U.S. Provisional Pat. No. 61/040,100, filed on Mar. 27, 2008, which is hereby incorporated by reference in its entirety.

Although incorporated by reference in its entirety, no arguments or disclaimers made in the parent application apply to this application. Any disclaimer that may have been stated in the specification of the above-referenced application is hereby expressly rescinded. Consequently, the Patent Office is asked to review the new set of claims in view of all of the prior art of record and any search that the Office deems appropriate.

### BACKGROUND OF THE INVENTION

1. Field of the Invention

The present invention generally relates to exercising equipments. More particularly, the present invention relates to a special hygienic exercise equipment; such exercise equipment includes at least one selected from the group consisting of a dumb bell, an exercise ball, a bar bell, a weight plate, a stress ball, a weight belt, an ankle weight, an wrist weight, a yoga mat, a floating board, and a jump rope. In particular, such special hygienic exercise equipment has a composition that includes bamboo charcoal powder.

2. Description of Related Art

In the trend towards better health care, exercise equipment is widely used and helps a user to achieve the effect of exercising. Typically, conventional weight trainer and gym ball are made of material with conventional color coating or protective coating. Over time, the equipment is covered with users' body fluid and bacteria, and therefore becomes a health hazard. There is a continuing need for new ways to protect users from germs and bacteria on the exercise equipment.

### BRIEF SUMMARY OF THE INVENTION

Accordingly, the present invention provides a hygienic exercise equipment with a special composition having bamboo charcoal. One of the preferred contemplated compositions allows the equipment to maintain dry and bacteria free for the equipment users.

To achieve the above advantage and in accordance with the purpose of the invention, as embodied and broadly described herein, the invention provides an exercise equipment with a special hygienic composition, wherein the composition includes a mixture of bamboo charcoal. The composition is mixed to create a mixture that is tailored to various designs for different exercise equipment, different parts of the exercise equipment and different portion of the exercise equipment.

The contemplated hygienic composition for exercise equipment has the combination of the following: bamboo charcoal, PVC, ZN-CA stabilizer, pour point depressant, ink, and at least one of DOP and ATBC. In a preferred embodiment, each particle of the solid has a largest transverse dimension of less than 100 microns.

In a preferred embodiment, the contemplated hygienic composition for exercise equipment contains bamboo charcoal from the range of 0.1% to 5%, PVC from the range of 35% to 56%, ZN-CA stabilizer from the range of 0.4% to 1.5%, pour point depressant from the range of 0.5% to 1.5%, ink from the range of 0 to 10%, DOP or ATBC from the range of 1.0% to 5%.

Further, it is contemplated that the composition is mixed to create a mixture, wherein the mixture is tailored to various designs of the exercise equipment such as a weight trainer (e.g., a weight belt, an ankle weight). Each weight trainer containing the mixture can be comfortably held by a hand or can be comfortably put on a hand, wrist, leg, or waist. The internal body in the weight trainer, can be mixed with a high-density solid powder having an extremely high density ranging from 0.5 g/cm.sup.3 to 6 g/cm.sup.3, preferably ranging from 4 g/cm.sup.3 to 6 g/cm.sup.3, so the weight trainer can have a high weight, even if fitted into the internal body with small volume. The contemplated composition can be included in the internal body, or on other parts of the weight trainer.

Another aspect of the invention is directed to a method of making hygienic exercise equipment which has the step of making a composition by mixing components to create a mixture, and the components include bamboo charcoal from 0.1 to 5%, PVC from 35 to 56%, ZN-CA stabilizer from 0.4 to 1.5%, pour point depressant from 0.5 to 1.5%, ink, and at least one of DOP and ATBC from 1.0 to 5.0% and then utilizing the mixture to make the desired exercise equipment.

It is to be understood that both the foregoing general description and the following detailed description are exemplary, and are intended to provide further explanation of the invention as claimed. Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view showing a weight trainer held on a hand according to an embodiment of the present invention.

FIGS. 2 and 3 are perspective and cross-sectional views showing an egg-shaped dumbbell according to an embodiment of the present invention.

FIGS. 4 and 5 are perspective and cross-sectional views showing a dumbbell according to an embodiment of the present invention.

FIGS. 6 and 7 are perspective and side views showing a dumbbell according to an embodiment of the present invention.

FIGS. 8 and 9 are perspective and cross-sectional views showing a dumbbell according to an embodiment of the present invention.

FIGS. 10 and 11 are perspective and cross-sectional views showing a weight trainer according to an embodiment of the present invention.

FIG. 12 is a perspective view showing a weight trainer put on a wrist or lower arm according to an embodiment of the present invention.

FIGS. 13 and 14 are perspective and cross-sectional views showing a weight trainer according to an embodiment of the present invention.

FIGS. 15 and 16 are perspective and cross-sectional views showing a weight trainer according to an embodiment of the present invention.

FIG. 17 is a perspective view showing a weight trainer put on an ankle or lower leg according to an embodiment of the present invention.

FIG. 18 is a perspective view showing a weight trainer according to an embodiment of the present invention.

FIG. 19 is a cross-sectional view showing two main loading parts and a rectangular ring of the weight trainer in FIG. 18.

FIGS. 20 and 21 are perspective and cross-sectional views showing a weight trainer according to an embodiment of the present invention.

FIGS. 22 and 23 are perspective and side views showing a weight trainer according to an embodiment of the present invention.

FIGS. 24 and 25 are perspective and cross-sectional views showing a weight trainer according to an embodiment of the present invention.

FIG. 26 is a perspective view showing a weight trainer with a hygiene coating.

FIG. 27 is a perspective view showing a gym ball with a hygiene coating.

### DETAILED DESCRIPTION OF THE INVENTION

Reference will now be made in detail to the present preferred embodiments of the invention, examples of which are illustrated in the accompanying drawings. Wherever possible, the same reference numbers are used in the drawings and the description to refer to the same or like parts.

Contemplated inventive subject matter is a hygienic exercise equipment having a composition, the composition comprises bamboo charcoal powder and PVC. All types of exercise equipment are contemplated. For example, a dumb bell, an exercise ball, a bar bell, a weight plate, a stress ball, a weight belt, an ankle weight, an wrist weight, a yoga mat, a floating board, and a jump rope.

The contemplated composition can further comprise ZN-CA stabilizer, pour point depressant, ink, and at least one of DOP and ATBC.

In a preferred embodiment, the ZN-CA stabilizer is from 0.4 to 1.5%. In a preferred embodiment, the pour point depressant is from 0.5 to 1.5%. In a preferred embodiment, DOP is from 1.0 to 5.0%. Yet in another preferred embodiment, the ATBC is from 1.0 to 5.0%.

In further preferred embodiments, the PVC is from 35 to 56%. In yet another preferred embodiment, the charcoal is from 0.1 to 5%, more preferably, 0.1 to 4%, even more preferably, 0.1 to 2%.

Optionally, the composition can comprise fragrance, perfume, or other fragrance-causing elements so as to eliminate odor, or to give off pleasant scent.

In some preferred embodiments, the exercise equipment can be entirely made of the composition. In yet other embodiments, the exercise equipment can be partially made of the composition. For example, the handle portion of an exercise equipment can be made of the composition.

In other preferred embodiments, the exercise equipment can have a coating layer, wherein the coating layer is made of the composition. Contemplated coating layer can occupy an entire surface area of the exercise equipment. Contemplated coating layer can also occupy only a portion of the surface area of the exercise equipment, for example, coating layer can dispose on a handle portion of the exercise equipment.

As used herein, the term “charcoal” in conjunction with the composition refers to a charcoal in various forms, for example, powder, paste, granules, liquid solution, and cubes. In the most preferred embodiment, charcoal is in fine powder form.

As used herein, the term “ink” in conjunction with the composition refers to typical color-producing elements such as dyes, used to produce color in the resultant product.

As mentioned above, all types of exercise equipment are contemplated. Examples of the exercise equipment will be described below.

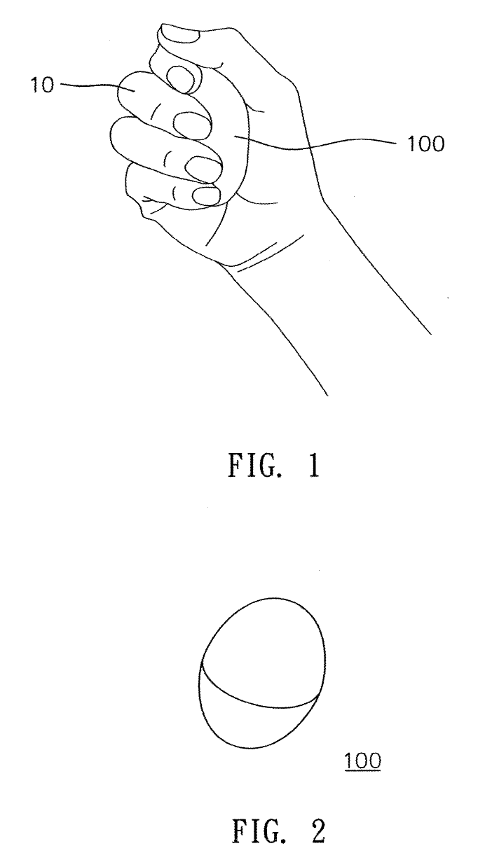

FIG. 1 is a perspective view showing a weight trainer held on a hand according to a preferred embodiment of the present invention. The weight trainer of the present invention used to train the muscle on a hand can be made with a dumbbell shape as shown in drawings. The weight trainer is soft, so hurting a body can be avoided when the weight trainer is slid from a hand.

The weight trainer 100 is an egg-shaped dumbbell. The muscle on an arm can be trained by repeatedly bending the arm at the elbow with holding the egg-shaped dumbbell 100 on a hand 10. Besides, the muscle on fingers can be trained by repeatedly bending the fingers with pressing the egg-shaped dumbbell 100.

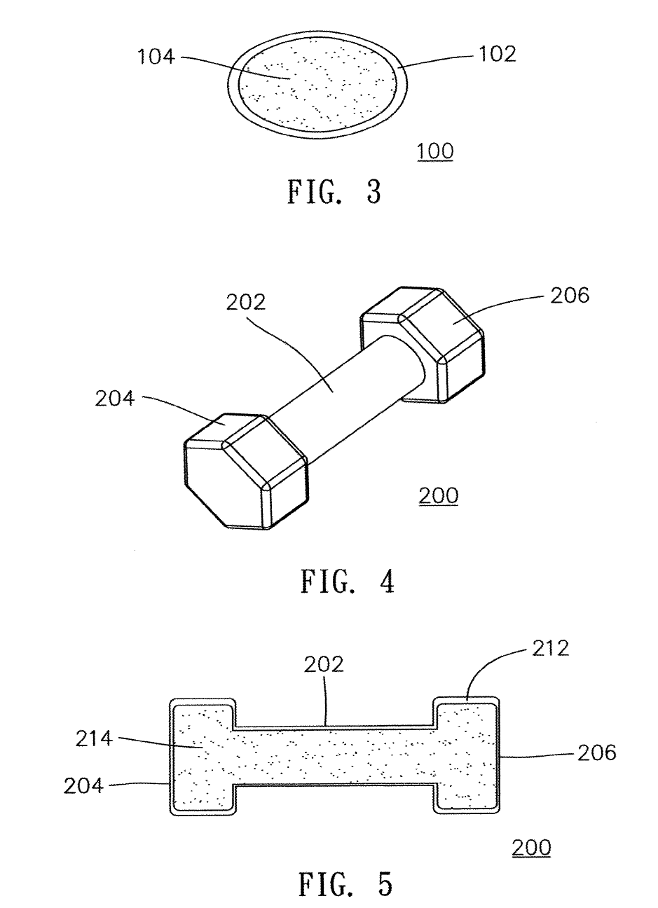

FIG. 2 is a perspective view showing the egg-shaped dumbbell 100 according to a preferred embodiment of the present invention. FIG. 3 is a cross-sectional view showing the egg-shaped dumbbell 100 of FIG. 2. The egg-shaped dumbbell 100 includes an enclosure 102 and an internal body 104, wherein the enclosure 102 encloses the internal body 104. The internal body 104 is formed by uniformly mixing a thermo plastic rubber or elastomer (TPR or TPE), a solid powder, and an oil. The thermo plastic rubber or elastomer may include polyvinyl chloride (PVC), thermoplastic vulcanizates elastomer (TPV), thermoplastic polyurethene elastomer (TPU), thermoplastic styrene elastomer (TPS), thermoplastic polyester elastomer (TPEE), polyamide elastomer (PAE) or styrene-class thermo plastic elastomer, for example. The styrene-class thermo plastic elastomer may include styrene-isoprene-styrene block copolymer (SIS), styrene-butadiene-styrene block copolymer (SBS), styrene-ethylene-butadiene-styrene block copolymer (SEBS), styrene-ethylene-propylene-styrene block copolymer (SEPS), styrene-ethylene-styrene block copolymer (SES), styreneic block copolymer (SBC), or styrene-butadiene rubber (SBR), for example. The internal body 104 has 5 to 20 weight percent of the thermo plastic rubber or elastomer, for example. The oil in the internal body 104 may be rubber extender oil, industrial oil, white oil, yellow oil or black oil, for example. The internal body 104 has 10 to 25 weight percent of the oil, for example. The solid powder may include iron powder, stone powder, mineral powder, copper powder, lead powder, tin powder, or some powder constituted from other metal or inorganic material. The internal body 104 has 60 to 85 weight percent of the solid powder, for example. In regards to iron powder, each particle of the iron powder has a largest transverse dimension of less than 100 microns, and preferably of between 1 micron and 100 microns, for example. Optionally, the internal body 104 may include dioctyl phthalate (DOP). The internal body 104 as described above has extremely high density of between 0.5 g/cm.sup.3 and 6 g/cm.sup.3 or between 3 g/cm.sup.3 and 6 g/cm.sup.3, for example, and preferably between 4 g/cm.sup.3 and 6 g/cm.sup.3. The enclosure 102 may include well ductile rubber and/or well ductile cloth and/or well ductile plastic.

Dumbbell 100 has a coating layer 101 made of the composition covering the entire surface area of dumbbell 100. Alternatively, the coating layer 101 can cover only a portion of the surface area of dumbbell 100.

Alternatively, the dumbbell used to be held on a hand may have other shapes, as shown in FIGS. 4 and 5. FIG. 4 is a perspective view showing a dumbbell according to a preferred embodiment of the present invention. FIG. 5 is a cross-sectional view showing the dumbbell in FIG. 4. The dumbbell 200 includes a holding stem 202 and two hexagonal-column ends 204 and 206, wherein two opposite ends of the holding stem 202 are respectively joined with the hexagonal-column ends 204 and 206. The muscle on an arm can be trained by repeatedly bending the arm at the elbow with holding the holding stem 202 of the dumbbell 200 on a hand. The dumbbell 200 is composed of an enclosure 212 and an internal body 214, wherein the enclosure 212 encloses the internal body 214. The principle materials of the enclosure 212 and the internal body 214 are the same as those of the enclosure 102 and the internal body 104 as described in FIG. 3.

Dumbbell 200 has a coating layer 201 made of the composition covering the entire surface area of dumbbell 200. Alternatively, the coating layer 201 can cover only a portion of the surface area of dumbbell 200. For example, in one embodiment, only the handle portion has the coating layer 201.

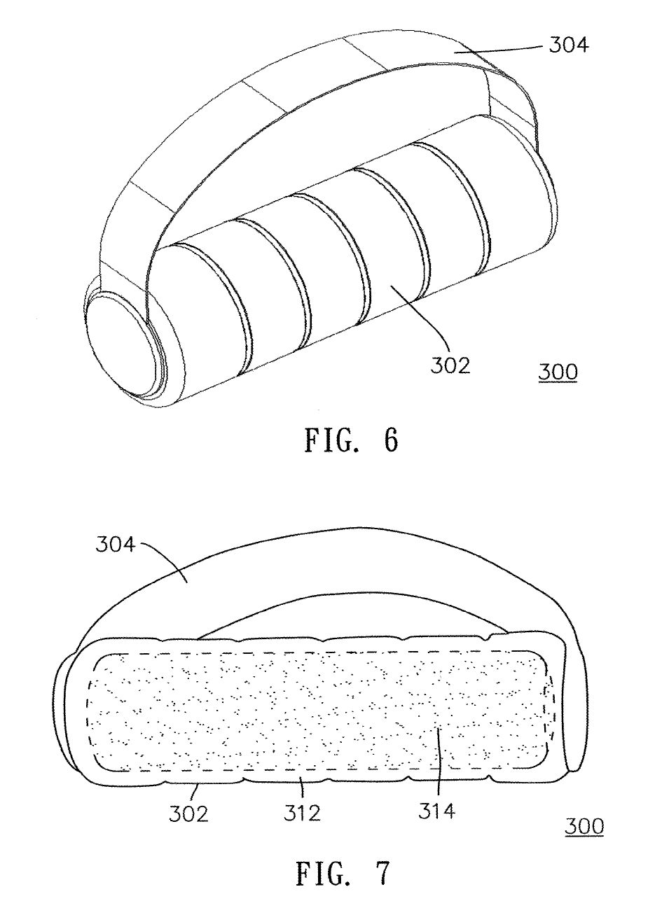

Alternatively, the dumbbell used to be held on a hand may have other shapes, as shown in FIGS. 6 and 7. FIG. 6 is a perspective view showing a dumbbell according to a preferred embodiment of the present invention. FIG. 7 is a side view showing the dumbbell in FIG. 6. The dumbbell 300 includes a cylinder 302 and a belt 304, wherein two ends of the belt 304 are respectively joined with two opposite ends of the cylinder 302. The muscle on an arm can be trained by repeatedly bending the arm at the elbow with holding the cylinder 302 of the dumbbell 300 on a hand, the belt 304 covering the back of the hand. The cylinder 302 of the dumbbell 300 is composed of an enclosure 312 and an internal body 314, wherein the enclosure 312 encloses the internal body 314. The principle materials of the enclosure 312 and the internal body 314 are the same as those of the enclosure 102 and the internal body 104 as described in FIG. 3.

Alternatively, the present invention provides a weight trainer that can be put on a hand, arm, wrist, leg, ankle or waist to train the muscle of the hand, leg or waist. The weight trainer is soft, so hurting a body or damaging a floor can be avoided when the weight trainer is slid from a hand.

Dumbbell 300 may be entirely made of the composition. Alternatively, dumbbell 300 has a coating layer 301 made of the composition covering the entire surface area of dumbbell 300. Alternatively, the coating layer 301 can cover only a portion of the surface area of dumbbell 300. For example, the coating layer 301 can cover only the cylinder 302, only the belt 304, or both.

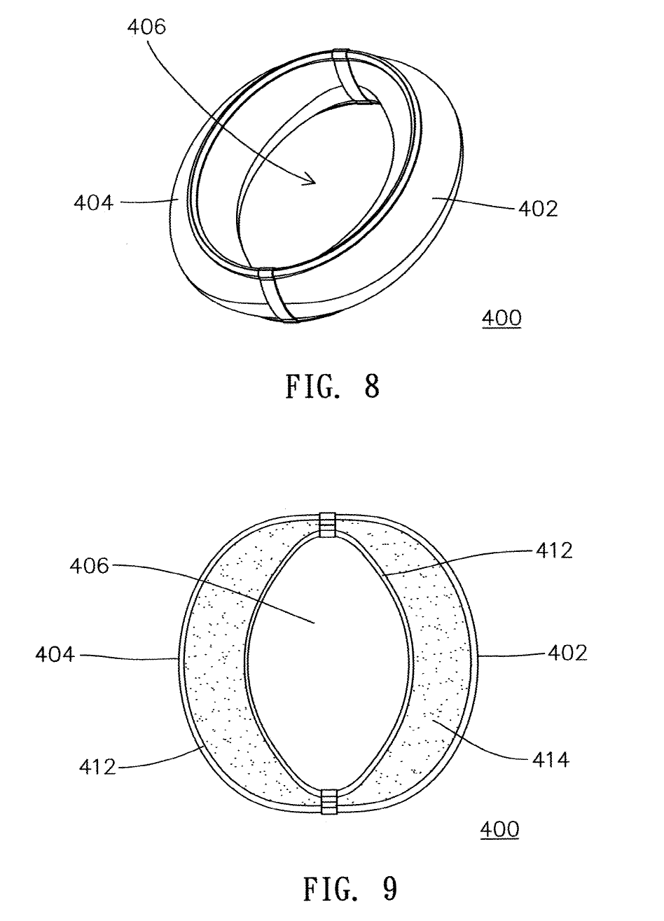

FIG. 8 is a perspective view showing a dumbbell according to another preferred embodiment of the present invention. FIG. 9 is a cross-sectional view showing the dumbbell in FIG. 8. The weight trainer 400 includes two arc portions 402 and 404, wherein both ends of the arc portions 402 and 404 are connected to each other. Weight training can be performed with a palm or foot passing through an opening 406 between the arc portions 402 and 404, leading the weight trainer 400 to be surroundingly mounted on a wrist or lower arm, or an ankle or lower leg. The arc portions 402 and 404 of the weight trainer 400 are composed of an enclosure 412 and an internal body 414, wherein the enclosure 412 encloses the internal body 414. The principle materials of the enclosure 412 and the internal body 414 are the same as those of the enclosure 102 and the internal body 104 as described in FIG. 3.

Weight trainer 400 may be entirely made of the composition. Alternatively, weight trainer 400 has a coating layer 401 made of the composition covering the entire surface area of weight trainer 400. Alternatively, the coating layer 401 can cover only a portion of the surface area of weight trainer 400. For example, the coating layer 401 can cover only the arc portions 402, 404, only the enclosure 412, or both.

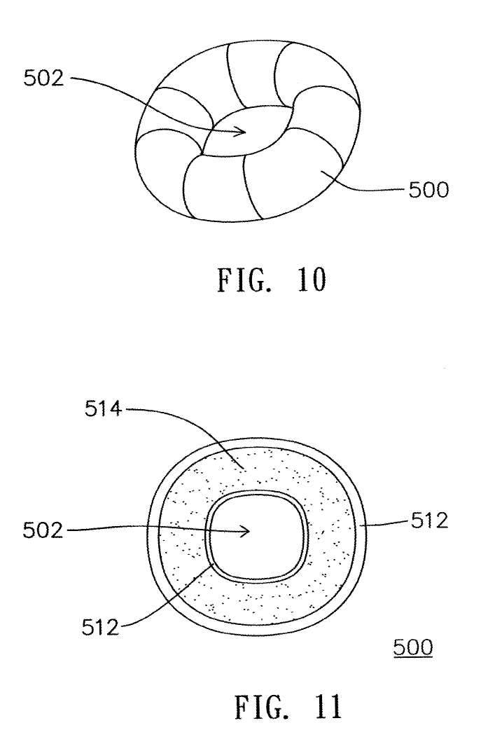

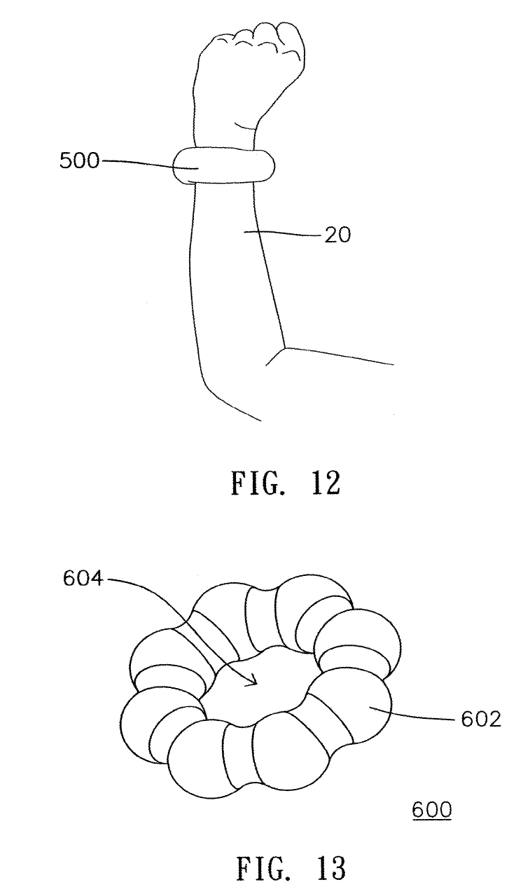

Alternatively, the weight trainer used to be surroundingly mounted on a wrist or lower arm, or an ankle or lower leg may have other shapes, as shown in FIGS. 10 and 11. FIG. 10 is a perspective view showing a weight trainer the present invention. FIG. 11 is a cross-sectional view showing the weight trainer in FIG. 10. The weight trainer 500 is ring-shaped. The opening 502 in the middle of the weight trainer 500 may have a hand 20 pass therethrough. Then, the weight trainer 500 can be surroundingly mounted on a wrist or lower arm of the hand 20, as shown in FIG. 12. FIG. 12 is a perspective view showing a weight trainer put on a hand. Alternatively, a foot may pass through the opening 502 in the middle of the weight trainer 500, and then the weight trainer 500 can be surroundingly mounted on an ankle or lower leg. The weight trainer 500 is composed of an enclosure 512 and an internal body 514, wherein the enclosure 512 encloses the internal body 514. The principle materials of the enclosure 512 and the internal body 514 are the same as those of the enclosure 102 and the internal body 104 as described in FIG. 3.

Weight trainer 500 may be entirely made of the composition. Alternatively, weight trainer 500 has a coating layer 501 made of the composition covering the entire surface area of weight trainer 500. Alternatively, the coating layer 501 can cover only a portion of the surface area of weight trainer 500.

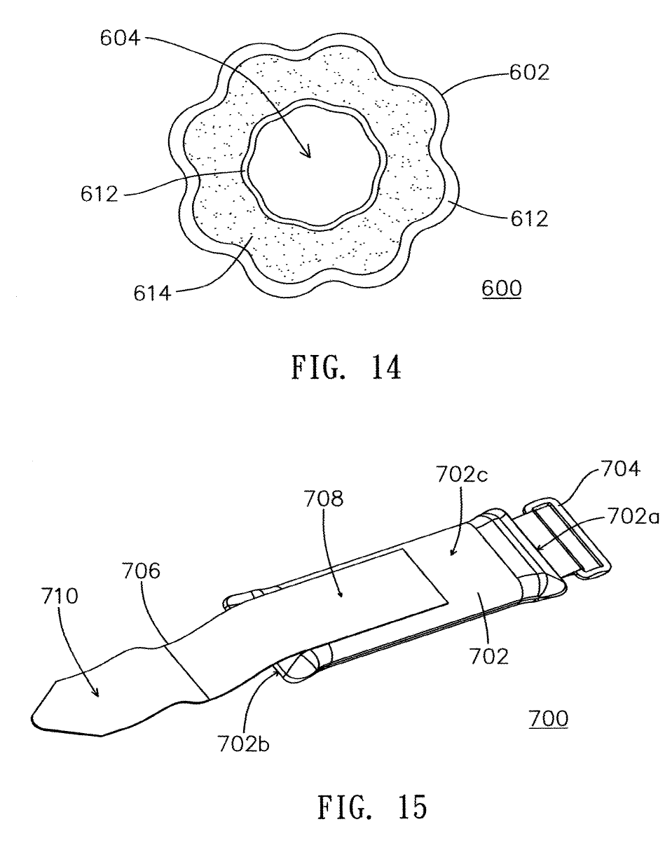

Alternatively, another ring-shaped weight trainer may be shown in FIGS. 13 and 14. FIG. 13 is a perspective view showing a weight trainer according to an embodiment of the present invention. FIG. 14 is a cross-sectional view showing the weight trainer in FIG. 13. The ring-shaped weight trainer 600 has ball-shaped bumps 602 surrounding an opening 604 in the middle of the weight trainer 600. Fixed intervals are spaced between the ball-shaped bumps 602. A palm may pass through the opening 604 in the middle of the weight trainer 600, and then the weight trainer 600 can be surroundingly mounted on a wrist or lower arm. Alternatively, a foot may pass through the opening 604 in the middle of the weight trainer 600, and then the weight trainer 600 can be surroundingly mounted on an ankle or lower leg. The weight trainer 600 is composed of an enclosure 612 and an internal body 614, wherein the enclosure 612 encloses the internal body 614. The principle materials of the enclosure 612 and the internal body 614 are the same as those of the enclosure 102 and the internal body 104 as described in FIG. 3.

Ring-shaped weight trainer 600 may be entirely made of the composition. Alternatively, ring-shaped weight trainer 600 has a coating layer 601 made of the composition covering the entire surface area of ring-shaped weight trainer 600. Alternatively, the coating layer 601 can cover only a portion of the surface area of ring-shaped weight trainer 600.

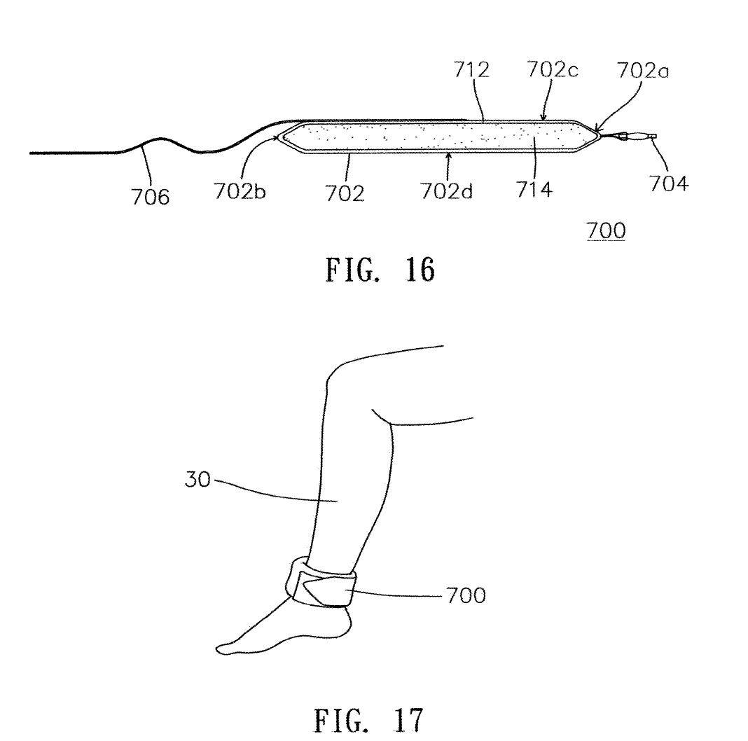

FIG. 15 is a perspective view showing a weight trainer according to another preferred embodiment of the present invention. FIG. 16 is a cross-sectional view showing the weight trainer in FIG. 15. The weight trainer 700 includes a main loading part 702, a rectangular ring 704 and a Velcro® tape 706. The rectangular ring 704 is fixed on an end 702a of the main loading part 702. The Velcro® tape 706 has a right side sewed on a top surface 702c of the main loading part 702 and outwardly extends from the other end 702b of the main loading part 702. A loop area 708 is on a top surface of the Velcro® tape 706 close to the main loading part 702, that is, on right and middle sides of the Velcro® tape 706. A hook area 710 is on a top surface of the Velcro® tape 706 far away from the main loading part 702, that is, on a left side of the Velcro® tape 706. In the process of putting the weight trainer 700 on an ankle or lower leg 30, first putting the lower surface 702d of the main loading part 702 on the ankle or lower leg 30 with surrounding the main loading part 702 about the ankle or lower leg 30, next moving the Velcro® tape 706 to pass through an opening in the middle of the rectangular ring 704 and then to turn back, making the hook area 710 be attached onto the loop area 708, as shown in FIG. 17. FIG. 17 is a perspective view showing a weight trainer put on an ankle or lower leg according to a preferred embodiment of the present invention. Alternatively, the weight trainer 700 may be put on a hand. In the process of putting the weight trainer 700 on a wrist or lower arm, first putting the lower surface 702d of the main loading part 702 on the wrist or lower arm with surrounding the main loading part 702 about the wrist or lower arm, next moving the Velcro® tape 706 to pass through an opening in the middle of the rectangular ring 704 and then to turn back, making the hook area 710 be attached onto the loop area 708. The main loading part 702 of the weight trainer 700 is composed of an enclosure 712 and an internal body 714, wherein the enclosure 712 encloses the internal body 714. The principle materials of the enclosure 712 and the internal body 714 are the same as those of the enclosure 102 and the internal body 104 as described in FIG. 3.

Weight trainer 700 has a coating layer 701 made of the composition covering the entire surface area of weight trainer 700. Alternatively, the coating layer 701 can cover only a portion of the surface area of weight trainer 700. For example, the coating layer 701 can cover at least one portion consisting of the main loading part 702, the rectangular ring 704, the Velcro® tape 706, the loop area 708, the hook area 710 and the enclosure 712.

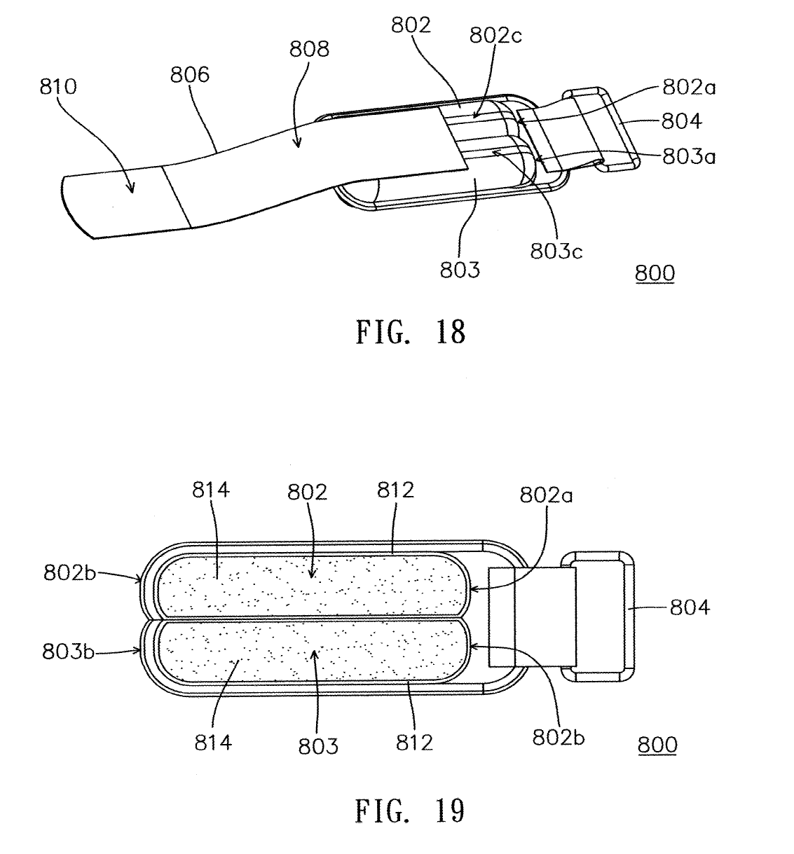

Alternatively, the present invention may provide a weight trainer 800 with a pair of main loading parts 802 and 803 shaped like long bars. The main loading parts 802 and 803 are lined with opposite long edges neighboring with each other, as shown in FIGS. 18 and 19. FIG. 18 is a perspective view showing a weight trainer according to an embodiment of the present invention. FIG. 19 is a cross-sectional view showing two main loading parts and a rectangular ring of the weight trainer in FIG. 18. A rectangular ring 804 is put on an end 802a and 803a of the opposite short edges of the main loading parts 802 and 803. A Velcro® tape 806 has a right side with a back sewed on a top surface 802c and 803c of the main loading parts 802 and 803 and outwardly extends from the other ends 802b and 803b of the opposite short edges of the main loading parts 802 and 803. A loop area 808 is on an upper surface of the Velcro® tape 806 close to the main loading parts 802 and 803, that is, on middle and right sides of the Velcro® tape 806. A hook area 810 is on an upper surface of the Velcro® tape 806 far away from the main loading parts 802 and 803, that is, on a left side of the Velcro® tape 806. In the process of putting the weight trainer 800 on some portion of a body, such as wrist, lower arm, ankle or lower leg, first putting the lower surface of the main loading parts 802 and 803 on the wrist, lower arm, ankle or lower leg, with surrounding the main loading parts 802 and 803 about the wrist, lower arm, ankle or lower leg, next moving the Velcro® tape 806 to pass through an opening in the middle of the rectangular ring 804 and then to turn back, making the hook area 810 be attached onto the loop area 808. The main loading parts 802 and 803 of the weight trainer 800 are composed of an enclosure 812 and an internal body 814, wherein the enclosure 812 encloses the internal body 814. The principle materials of the enclosure 812 and the internal body 814 are the same as those of the enclosure 102 and the internal body 104 as described in FIG. 3.

Weight trainer 800 has a coating layer 801 made of the composition covering the entire surface area of weight trainer 800. Alternatively, the coating layer 801 can cover only a portion of the surface area of weight trainer 800. For example, the coating layer 801 can cover at least one portion consisting of the main loading parts 802, 803, the rectangular ring 804, the ends 802a, 803a, the Velcro® tape 806, the top surface 802c, 803c, the other ends 802b, 803b, the loop area 808, the hook area 810 and the enclosure 812.

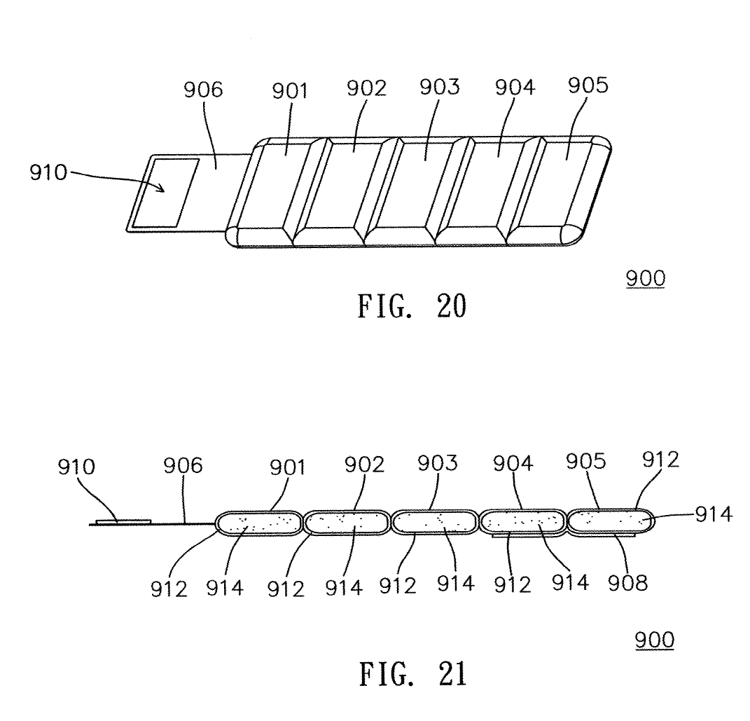

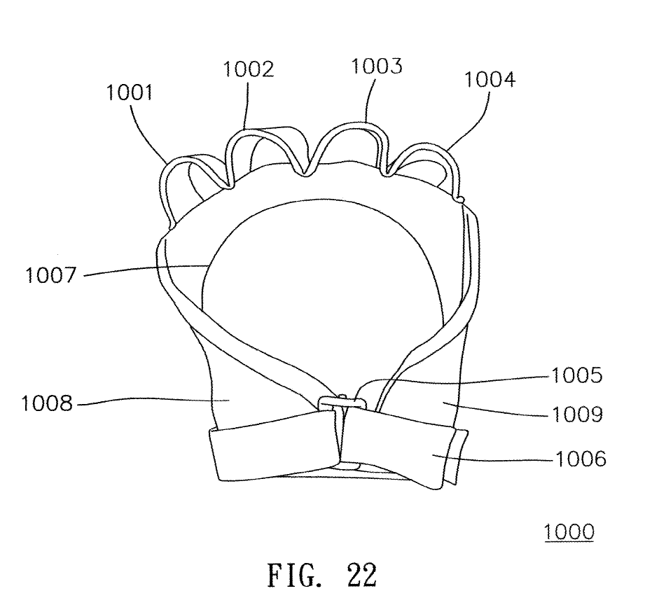

Alternatively, the present invention may provide a weight trainer 900 with a multiplicity of main loading parts 901, 902, 903, 904 and 905 shaped like long and flat bodies. The main loading parts 901, 902, 903, 904 and 905 are lined with opposite long edges neighboring with each other, as shown in FIGS. 20 and 21. FIG. 20 is a perspective view showing a weight trainer according to a preferred embodiment of the present invention. FIG. 21 is a cross-sectional view showing the weight trainer in FIG. 20. A Velcro® tape 906 is connected to the leftmost main loading part 901. A hook area 910 is on a top surface of the Velcro® tape 906. A loop area 908 is on a lower surface of the two rightmost main loading parts 904 and 905. In the process of putting the weight trainer 900 on some portion of a body, such as wrist, lower arm, ankle, lower leg or waist, first putting the upper surface of the main loading parts 901, 902, 903, 904 and 905 on the wrist, lower arm, ankle, lower leg or waist, with surrounding the main loading parts 901, 902, 903, 904 and 905 about the wrist, lower arm, ankle, lower leg or waist, next moving the Velcro® tape 906 to make the hook area 910 be attached onto the loop area 908. The main loading parts 901, 902, 903, 904 and 905 of the weight trainer 900 are composed of an enclosure 912 and an internal body 914, wherein the enclosure 912 encloses the internal body 914. The principle materials of the enclosure 912 and the internal body 914 are the same as those of the enclosure 102 and the internal body 104 as described in FIG. 3.

Weight trainer 900 has a coating layer 907 made of the composition covering the entire surface area of weight trainer 900. Alternatively, the coating layer 907 can cover only a portion of the surface area of weight trainer 900. For example, the coating layer 907 can cover at least one portion consisting of the main loading parts 901, 902, 903, 904, 905, the Velcro® tape 906, the loop area 908 and the enclosure 912.

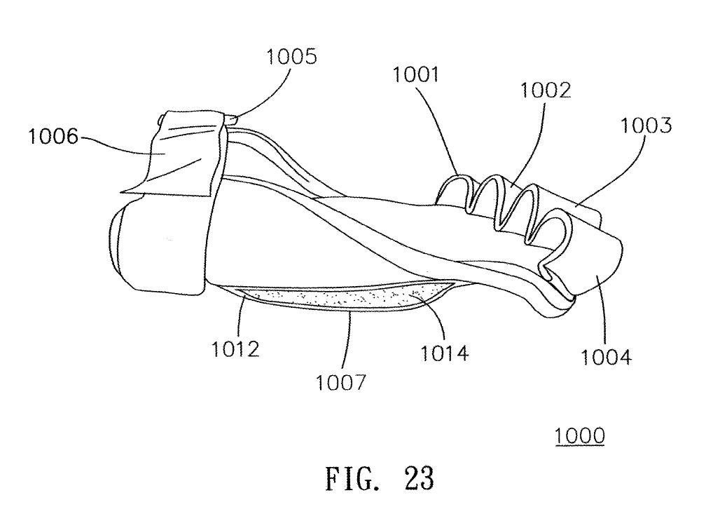

Alternatively, the present invention may provide a glove-shaped weight trainer 1000, as shown in FIGS. 22 and 23. FIG. 22 is a perspective view showing a weight trainer according to another preferred embodiment of the present invention. FIG. 23 is a cross-sectional view showing the weight trainer in FIG. 22. The weight trainer 1000 may include four finger stalls 1001, 1002, 1003 and 1004 used to have fingers pass therethrough. The finger stalls 1001, 1002, 1003 and 1004 are lined on an upper side of the weight trainer 1000. The openings in the finger stalls 1001, 1002, 1003 and 1004 may allow an index finger, middle finger, ring finger and little finger of a left hand to pass therethrough, respectively, or may allow a little finger, ring finger, middle finger and index finger of a right hand to pass therethrough, respectively. A rectangular ring 1005 is mounted on a left wing of the glove-shaped weight trainer 1000. A Velcro® tape 1006 outwardly extends from a right wing of the glove-shaped weight trainer 1000. A main loading part 1007 is sewed on an outer surface of the glove-shaped weight trainer 1000. In the process of putting the weight trainer 1000 on a left or right palm, first moving the index finger, middle finger, ring finger and little finger of the left palm to pass through openings in the middle of the finger stalls 1001, 1002, 1003 and 1004 or moving the little finger, ring finger, middle finger and index finger of the right palm to pass through openings in the middle of the finger stalls 1001, 1002, 1003 and 1004, making the back of the left or right palm lean against the inner surface of the weight trainer 1000, next moving the Velcro® tape 1006 to pass through an opening in the middle of the rectangular ring 1005 and then to turn back, making an hook area on a lower surface of the Velcro® tape 1006 be attached onto a loop area 1008 around the bottom end of the weight trainer 1000. The main loading part 1007 of the weight trainer 1000 is composed of an enclosure 1012 and an internal body 1014, wherein the enclosure 1012 encloses the internal body 1014. The principle materials of the enclosure 1012 and the internal body 1014 are the same as those of the enclosure 102 and the internal body 104 as described in FIG.3.

Weight trainer 1000 has a coating layer 1115 made of the composition covering the entire surface area of weight trainer 1000. Alternatively, the coating layer 1115 can cover only a portion of the surface area of weight trainer 1000. For example, the coating layer 1115 can cover at least one portion consisting of the finger stalls 1001, 1002, 1003, 1004, the rectangular ring 1005, the Velcro® tape 1006, the main loading part 1007, the loop area 1008 and the enclosure 1012.

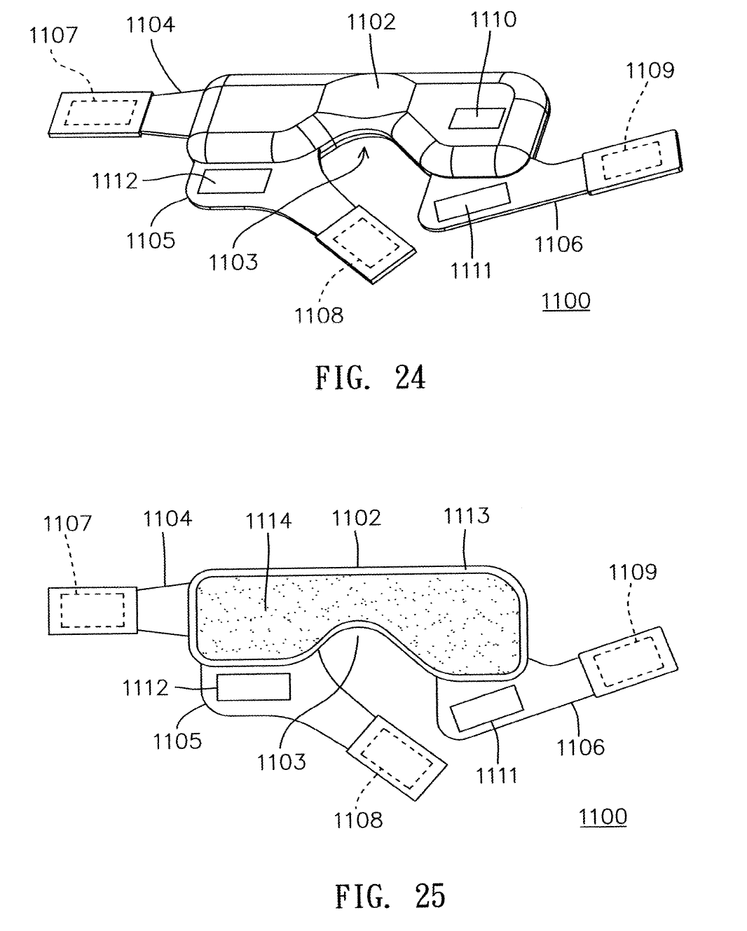

Alternatively, the present invention may provide a weight trainer 1100 as shown in FIGS. 24 and 25. FIG. 24 is a perspective view showing a weight trainer according to another preferred embodiment of the present invention. FIG. 25 is a cross-sectional view showing the weight trainer in FIG. 24. The weight trainer 1100 may include a main loading part 1102 with a recess portion 1103 in which the part between a thumb and an index finger of a left or right hand can be put. A Velcro® tape 1104 is connected to a left edge of the main loading part 1102 and leftward extends from the left side of the main loading part 1102. A Velcro® tape 1105 is connected to a bottom edge of a left part of the main loading part 1102 and rightward extends from the bottom edge of the left part of the main loading part 1102. A Velcro® tape 1106 is connected to a bottom edge of a right part of the main loading part 1102 and rightward extends from the bottom edge of the right part of the main loading part 1102. Multiple hook areas 1107, 1108 and 1109 are on a lower surface of the Velcro® tapes 1104, 1105 and 1106, respectively. Multiple loop areas 1110, 1111 and 1112 are on a right side of the main loading part 1102, and on the Velcro® tapes 1105 and 1106, respectively. The hook areas 1107, 1108 and 1109 are adapted to be attached onto the loop areas 1110, 1111 and 1112, respectively. In the process of putting the weight trainer 1100 on a left of right palm, first putting the part between the thumb and the index finger of the left or right palm on the recess portion 1103 of the main loading part 1102, next bending the main loading part 1102 with moving the left and right parts of the main loading part 1102 to the back and center portions of the left palm respectively, or with moving the left and right parts of the main loading part 1102 to the center and back portions of the right palm respectively, next moving the Velcro® tapes 1104, 1105 and 1106 to attach the hook areas 1107, 1108 and 1109 onto the loop areas 1110, 1111 and 1112. The main loading part 1102 of the weight trainer 1100 is composed of an enclosure 1113 and an internal body 1114, wherein the enclosure 1113 encloses the internal body 1114. The principle materials of the enclosure 1113 and the internal body 1114 are the same as those of the enclosure 102 and the internal body 104 as described in FIG. 3.

Weight trainer 1100 has a coating layer 1116 made of the composition covering the entire surface area of weight trainer 1100. Alternatively, the coating layer 1116 can cover only a portion of the surface area of weight trainer 1100. For example, the coating layer 1116 can cover at least one portion consisting of the finger main loading part 1102, the recess portion 1103, the Velcro® tape 1104, the multiple hook areas 1107, 1108, 1109, the Velcro® tapes 1104, 1105, 1106, the multiple loop areas 1110, 1111, 1112 and the enclosure 1113.

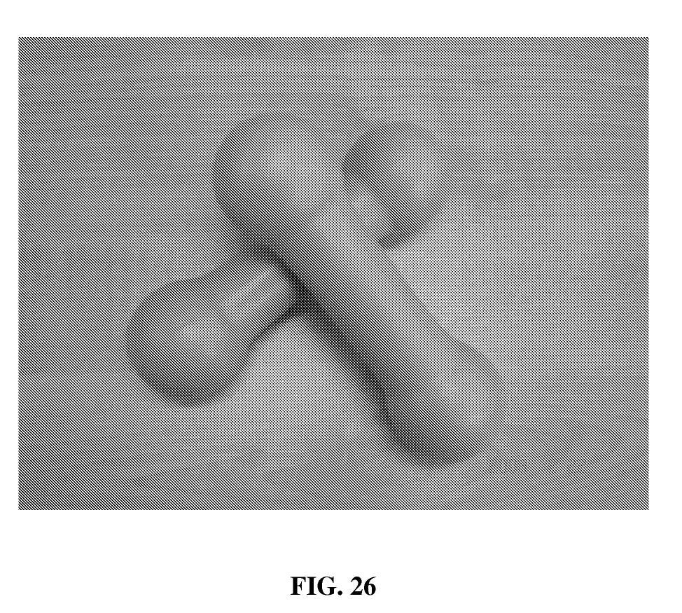

FIG. 26 is a perspective view showing a dumbbell 1200 according to a preferred embodiment of the present invention. The dumbbell 1200 includes a holding stem 1202 and two round ends 1204, 1206. Dumbbell 1200 has a coating layer 1201 made of the composition covering the entire surface area of dumbbell 1200. Alternatively, the coating layer 1201 can cover only a portion of the surface area of dumbbell 1200.

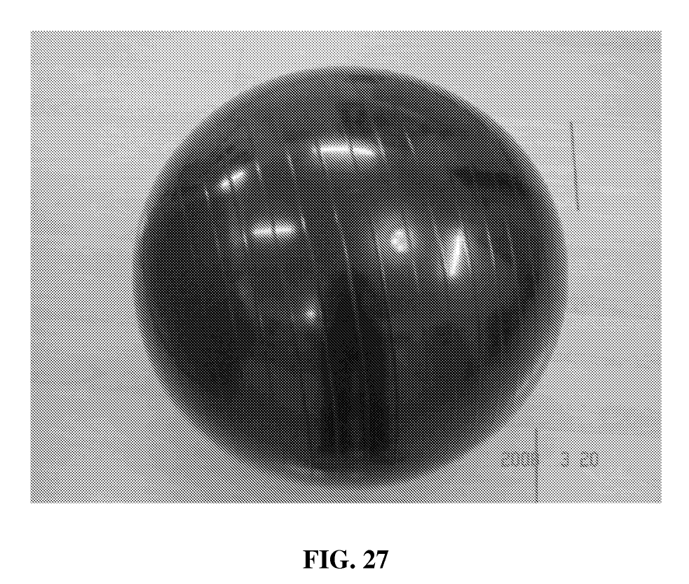

FIG. 27 is a perspective view showing a gym ball 1300 according to another preferred embodiment of the present invention. The gym ball 1300 has a coating layer 1301 made of the composition covering the entire surface area of gym ball 1300. Alternatively, the coating layer 1301 can cover only a portion of the surface area of gym ball 1300. In a preferred embodiment, the entire gym ball 1300 is made of the composition.

Furthermore, the contemplated composition as described above may also be directed to a method of making hygienic exercise equipments which has the step of making a composition by mixing components to create a mixture wherein the components include bamboo charcoal from 0.1 to 5%, PVC from 35 to 56%, ZN-CA stabilizer from 0.4 to 1.5%, pour point depressant from 0.5 to 1.5%, ink, and at least one of DOP from 1.0 to 5.0% and ATBC from 1.0 to 5.0% and then utilizing the mixture to make the desired exercise equipment. The desired coating can be applied to an exercise equipment by spraying, dipping, or other known techniques. In embodiments where the exercise equipement is entirely made or partially made of the composition, it can be made by pouring into a mold, or other known techniques.

To sum up, each exercise equipment disclosed in the present invention is a hygienic exercise equipment that contains thermo plastic elastomer having a composition comprising bamboo charcoal, PVC, ZN-CA stabilizer, pour point depressant, ink and at least one of DOP and ATBC. The composition is mixed to create a mixture, the mixture is tailored to various designs for the weight trainer.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Thus, specific embodiments and applications of the hygienic exercise equipment and the manufacturing method thereof have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the invention. In addition, where the specification and claims refer to at least one of something selected from the group consisting of A, B, C . . . and N, the text should be interpreted as requiring only one element from the group, not A plus N, or B plus N, etc.

1. A hygienic exercise equipment having a composition, the composition comprising:
bamboo charcoal powder;
PVC; and
wherein the exercise equipment is at least one selected from the group consisting of a dumb bell, an exercise ball, a bar bell, a weight plate, a stress ball, a weight belt, an ankle weight, an wrist weight, a yoga mat, a floating board, a gym ball, and a jump rope.

2. The exercise equipment of claim 1, the composition further comprising ZN-CA stabilizer, pour point depressant, ink, and at least one of DOP and ATBC.

3. The exercise equipment of claim 2, wherein the ZN-CA stabilizer is from 0.4 to 1.5%, wherein the pour point depressant is from 0.5 to 1.5%, wherein DOP is from 1.0 to 5.0%, and wherein the ATBC is from 1.0 to 5.0%.

4. The exercise equipment of claim 2, wherein the PVC is from 35 to 56% and the charcoal is from 0.1 to 5%.

5. The exercise equipment of claim 4 further comprising a coating layer, wherein the coating layer is made of the composition.

6. The exercise equipment of claim 5, wherein the coating layer disposed on a handle portion of the exercise equipment.

7. The exercise equipment of claim 5, wherein the coating layer occupies an entire surface area of the exercise equipment.

8. The exercise equipment of claim 4, wherein the exercise equipment is entirely made of the composition.

9. The exercise equipment of claim 1, wherein the composition further comprising fragrance.

10. A composition for making a hygienic exercise equipment, the composition comprising:
bamboo charcoal;
PVC;
ZN-CA stabilizer;
pour point depressant;
ink; and
at least one of DOP and ATBC.

11. The composition of claim 10, wherein the bamboo charcoal is from 0.1 to 5%, wherein the PVC is from 35 to 56%, wherein the ZN-CA stabilizer is from 0.4 to 1.5%, wherein the pour point depressant is from 0.5 to 1.5%, wherein DOP is from 1.0 to 5.0%, and wherein the ATBC is from 1.0 to 5.0%.

12. The composition of claim 11, wherein the entire exercise equipment is made of the composition.

13. The composition of claim 11, wherein at least a part of the exercise equipment is made by the composition.

14. The composition of claim 11, wherein the exercise equipment has at least a layer made by the composition.

15. The composition of claim 13, wherein the part of the exercise equipment made of the composition is selected from the group consisting of a handle, a seat, a belt, a user display, a user control panel, and a conveyor belt of a treadmill.

16. The composition of claim 13, wherein the exercise equipment is a member selected from the group consisting of a yoga mat, a floating board, a jump rope, a dumb bell, an exercise ball, a bar bell, a weight plate, a stress ball, a weight belt, an ankle weight, a gym ball, and an wrist weight.

17. A method of making a hygienic exercise equipment, the method comprising:
making a composition by mixing a plurality of components to create a mixture, the components include bamboo charcoal from 0.1 to 5%, PVC from 35 to 56%, ZN-CA stabilizer from 0.4 to 1.5%, pour point depressant from 0.5 to 1.5%, ink, and at least one of DOP from 1.0 to 5.0% and ATBC from 1.0 to 5.0%; and
utilizing the mixture to make at least a part of the exercise equipment.

18. The method of claim 17 further comprising a step of applying the mixture onto a desired portion of the exercise equipment.

19. The method of claim 17 further comprising a step of pouring the mixture into a mold to make at least a part of the exercise equipment.

20. The method of claim 17, wherein the mixture further comprising fragrance.
